(19) United States
(12) Patent Application Publication
(10) Pub. No.: US 2002/0034570 A1
(43) Pub. Date: Mar. 21, 2002

(54) Cheese flavoring

(76) Inventors: Gerhard Krammer, Holzminden (DE); Peter Werkhoff, Hoxter (DE); Gunther Hansmann, Holzminden (DE); Silke Hilmer, Hoxter (DE)

Correspondence Address: BAYER CORPORATION, PATENT DEPARTMENT, 100 BAYER ROAD, PITTSBURGH, PA, 15205, US

(21) Appl. No.: 09/871,059

(22) Filed: May 31, 2001

(30) Foreign Application Priority Data
Jun. 7, 2000 (DE) 10028225.3

(51) Int. Cl. A23L 1/22; A23L 2/56

(52) U.S. Cl. 426/534; 426/582

(57) ABSTRACT

Cheese flavoring containing both volatile and non-volatile components which comprise constituents which contribute to the taste sensation “cheese”.

### FIELD OF THE INVENTION

The invention relates to a system of individual components which give rise to the taste sensation “cheese” in the individual flavors; the use thereof for flavoring various foods and drinks and preparation thereof.

### BACKGROUND OF THE INVENTION

The taste sensation “cheese” is composed of various volatile and non-volatile components which are formed in the production of cheese from milk. In addition, taste-relevant ingredients, for example common salt, are used in cheese production.

The taste sensation “cheese” in the context of the present invention corresponds to the organoleptic perception as with preparations in which the cheese is produced by precipitation of solid constituents from milk which contain a mixture of protein (casein), milk fat and salts and which are subjected to a ripening process by bacteria and molds. During the ripening process, the components are formed, which determine the cheese taste.

Individual odor-active and taste-active components have already been evaluated with respect to their importance for cheese flavor using model systems (Z. Lebensm. unter S. Forsch. (1996) 202: 30-34; Int. Dairy Journal 7 (1997) 65-70). In Z. Lebensm. unter S. Forsch. (1996) 202: 30-34, the volatile constituents (odor-active components) of Swiss cheese, which are mentioned are the compound 3-methylbutanal, ethyl butyrate, ethyl 3-methylbutyrate, ethylhexanoate, methional, 4-hydroxy-2,5-dimethyl-3(2H)-furanone, 5-ethyl-4-hydroxy-2-methyl-3(2H)-furanone and δ-decalactone and the non-volatile components (taste-active compounds), which are mentioned are the compounds acetic acid, propionic acid, butyric acid, ammonium hydroxide, lactic acid, glutamic acid, sodium chloride, sodium dihydrogen phosphate, potassium dihydrogen phosphate, calcium hydroxide, magnesium hydroxide, sodium hydroxide, histamine, 3-methylbutyric acid, hexanoic acid, octanoic acid, decanoic acid and lauric acid.

Foods which give the taste sensation “cheese” on consumption are currently produced, inter alia, from natural cheese, milk fat products, enzyme-modified cheese (EMC), yeast extract and volatile flavor compounds.

It is also known that “cheese” , contains various components which make a contribution to the cheese flavor, while other components have a nutritional and/or filler function. In the production of foods, the individual components could not be used independently of one another. Furthermore, the amounts and necessary combinations of all substances relevant to flavor were not known.

### SUMMARY OF THE INVENTION

The object of the present invention is the provision of cheese voring of components which make a contribution to the taste sensation “cheese”.

Accordingly, the present invention relates to a cheese flavor containing:

A) volatile component contents which include

i) from 5 to 200 parts by weight of compounds having acidic and acetic-acid-like flavors (Group 1);

ii) from 0.1 to 10.0 parts by weight of compounds having milk-like and creamy flavors or cream-like or caramel-like flavors (Group 2);

iii) from 0.03 to 6.0 parts by weight of compounds having fruity and flowery flavors (Group 3);

iv) from 0.01 to 15.0 parts by weight of compounds having strong flavors, blue mold flavors and rind flavors (Group 4);

v) from 0.003 to 15.0 parts by weight of compounds having fatty flavors (Group 5);

vi) from 0 to 0.05 parts by weight of compounds having animal flavors (Group 6);

vii) from 0.0003 to 0.6 parts by weight of compounds having roasted flavors and cocoa-like flavors and also smoky flavors (Group 7);

viii) from 0.00005 to 0.1 parts by weight of compounds having vegetable-like flavors (Group 8);

ix) from 0 to 0.1 parts by weight of compounds having mushroom-like flavors or soft-cheese-like flavors (Group 9);

B) non-volatile component contents containing:

i) from 100 to 480 parts by weight of compounds having the taste impression salty (Group 10);

ii) from 50 to 550 parts by weight of compounds having the taste impression sour (Group 11);

iii) from 5 to 200 parts by weight of compounds having astringent, bitter notes (Group 12);

iv) from 0 to 100 parts by weight of compounds having the taste impression sweet (Group 13); and

v) from 0 to 140 parts by weight of compounds having a glutamate-like taste impression (umami) (Group 14).

### DETAILED DESCRIPTION OF THE INVENTION

To achieve the object, the volatile and non-volatile components were classified into the following groups according to Table 1:

TABLE 1

| | | |
|---|---|---|
| Flavor | Group 1 | acidic flavors, acetic-acid-like flavors |
| properties | Group 2 | milk-like, creamy flavors, cream-like, |
| | | caramel-like flavors |
| | Group 3 | fruity, flowery flavors |
| | Group 4 | strong flavors, blue mold flavors, rind flavors |
| | Group 5 | fatty flavors |
| | Group 6 | animal flavors |
| | Group 7 | roasted flavors and cocoa-like flavors, |
| | | smoky flavors |
| | Group 8 | vegetable-like flavors |
| | Group 9 | mushroom-like flavors, soft-cheese-like flavors |
| Taste | Group 10 | salty taste |
| properties | Group 11 | sour taste |
| | Group 12 | astringent, bitter notes |
| | Group 13 | sweet taste |
| | Group 14 | umami taste, glutamate-like |

Cheese flavoring has been found to have volatile component contents ranging from 5 to 200 parts by weight of compounds having acidic and acetic-acid-like flavors (Group 1), from 0.1 to 10.0 parts by weight of compounds having milk-like and creamy flavors or cream-like or caramel-like flavors (Group 2), from 0.03 to 6.0 parts by weight of compounds having fruity and flowery flavors (Group 3), from 0.01 to 15.0 parts by weight of compounds having strong flavors, blue mold flavors and rind flavors (Group 4), from 0.003 to 15.0 parts by weight of compounds having fatty flavors (Group 5), from 0 to 0.05 parts by weight of compounds having animal flavors (Group 6), from 0.0003 to 0.6 parts by weight of compounds having roasted flavors and cocoa-like flavors and also smoky flavors (Group 7), from 0.00005 to 0.1 parts by weight of compounds having vegetable-like flavors (Group 8), from 0 to 0.1 parts by weight of mushroom-like flavors or soft-cheese-like flavors (Group 9) and having non-volatile component contents of from 100 to 480 parts by weight of compounds having the taste impression salty (Group 10), from 50 to 550 parts by weight of compounds having the taste impression sour (Group 11), from 5 to 200 parts by weight of compounds having astringent, bitter notes (Group 12), from 0 to 100 parts by weight of compounds having the taste impression sweet (Group 13) and from 0 to 140 parts by weight of compounds having a glutamate-like taste impression (umami) (Group 14).

The substances of Groups 1 to 9 are used for producing premix A. The substances of groups 10 to 14 are used for producing premix B.

“Cheese flavoring” in the context of the present invention gives, upon consumption, the taste sensation “cheese”.

The individual groups, as constituent of the inventive cheese flavoring, are described as follows:

Compounds of Group 1 having acidic flavors and acetic-acid-like flavors are, for example, carboxylic acids having from 2 to 16 carbon atoms. Preferred compounds of Group 1 are acetic acid, propionic acid, butyric acid, valeric acid, caprylic acid, caproic acid, capric acid, lauric acid and myristic acid.

Compounds of Group 2 having the milk-like and creamy flavors are saturated and unsaturated δ- and γ-lactone having 6 to 14 carbon atoms. Preferred compounds of this group are jasmine lactone, δ-decalactone, δ-octalactone, δ-undecalactone, δ-dodecalactone and δ-tetradecalactone and γ-caprolactone, γ-heptalactone, γ-octalactone, γ-decalactone and δ-dodecalactone. In addition, hydroxy ketones and diketones having 4 to 8 carbon atoms are of importance. Preferred compounds are acetoin and diacetyl. Group 2 having milk-like creamy flavors also includes compounds having a caramel-like flavor. Preferred compounds are 4-hydroxy-2,5-dimethyl-3(2H)-furanone and 5-ethyl-4-hydroxy-2-methyl-3(2H)-furanone. Furthermore, aromatic aldehydes are mentioned as compounds of Group 2 having milk-like and creamy flavors. Preferred compounds of Group 2 are vanillin and vanillin derivatives.

Compounds of Group 3 having fruity and flowery flavors are the ethyl, propyl and butyl esters of unbranched and branched carboxylic acids having 2 to 12 carbon atoms. Preferred compounds of Group 3 are ethyl propionate, ethyl butyrate, ethyl caprylate, ethyl caprate, ethyl caproate, ethyl isobutyrate, ethyl isovalerate and also propyl caprylate and butyl acetate. The group of compounds having flowery flavors also includes saturated, unsaturated, unbranched and branched alcohols and aldehydes. Preferred compounds are 2-pentanol, isoamyl alcohol, hexanol, methyl 2-methylbutyrate, 3-methyl-2-butenol and 2-phenylethyl alcohol. Preferred aldehydes are benzaldehyde, phenylacetaldehyde and (E)-2-phenylbutenal.

Compounds of Group 4 having strong flavors, blue mold flavors and rind flavors are 2-alkanones and 2-alkanols having 5 to 12 carbon atoms. Preferred compounds of Group 4 are 2-pentanone, 2-heptanone, 2-octanone, 2-decanone and 2-nonanone. Preferred 2-alkanols are 2-heptanol and 2-nonanol.

Compounds of Group 5 having fatty and creamy flavors are unbranched aliphatic aldehydes and alcohols having from 7 to 14 carbon atoms. Preferred compounds of Group 5 are heptanal, nonanal, undecanal, dodecanal and tridecanal. Further preferred compounds can be heptanol, octanol and nonanol. In addition, compounds having fatty and creamy flavors of Group 5 can be unsaturated aldehydes having 8 to 15 carbon atoms. Preferred compounds are (E)-2-nonenal, (E)-2-decenal and (E)-2-undecenal. Further compounds of this group are 2-alkanones having 6 to 16 carbon atoms, preferably 2-heptanone, 2-nonanone, 2-undecanone, 2-tridecanone and 2-pentadecanone. In addition, compounds of Group 5 can be the esters of long-chain unbranched fatty acids. Preferred compounds are the ethyl esters of long-chain fatty acids such as ethyl laurate.

Compounds of Group 6 having animal flavors are nitrogen compounds, preferably scatole and indole, sulfur compounds, preferably hydrogen sulfide and methyl mercaptan and branched fatty acids, preferably 4-methyloctanoic acid, 4-methyinonanoic acid and 4-ethyloctanoic acid.

Compounds of Group 7 having roasted flavors are pyrazines which are monosubstituted or polysubstituted (monosubstituted to trisubstituted) with lower alkyl groups. Preferred compounds of Group 7 are 2,3,5-trimethylpyrazine and 2,6-dimethylpyrazine. Further compounds of Group 7 having roasted, cocoa-like flavors are branched aldehydes having 4 and 5 carbon atoms. A preferred compound here is isovaleraldehyde. Further compounds of Group 7 having roasted, smoky flavors are phenols and alkylfurans, preferably para- and ortho-cresol.

Compounds of Group 8 having vegetable-like flavors are lower-alkyl-substituted thio compounds (1 to 4 carbon atoms), thiols and thio-aldehydes. Preferred compounds are methanethiol, dimethyl sulfide, dimethyl disulfide, dimethyl trisulfide and 3-methylthiopropanal.

Compounds of Group 9 having mushroom-like and soft-cheese-like flavors are saturated and unsaturated alcohols and ketones having 8 carbon atoms. Preferred compounds of Group 9 are 3-octanol, 1-octen-3-one and 1-octen-3-ol.

Compounds of Group 10, which give the taste impression “salty” are salts having the cations sodium, ammonium, potassium, magnesium and calcium and anions such as chloride, hydrogen phosphate, dihydrogen phosphate, acetate and sulfate. Preferred compounds of Group 10 mentioned are sodium chloride, calcium chloride dihydrate, magnesium chloride, ammonium chloride, sodium dihydrogen phosphate, potassium dihydrogen phosphate, ammonium acetate, ammonium sulfate and diammonium hydrogen phosphate.

Compounds of Group 11 which give the sour taste properties are monocarboxylic, dicarboxylic and tricarboxylic acids having 2 to 8 carbon atoms. Preferred compounds of Group 11 are lactic acid, citric acid, succinic acid, pyruvic acid, orotic acid, fumaric acid, adipic acid and pyroglutamic acid. Further compounds of Group 11 having sour taste are amino acids, preferably L-aspartic acid, L-glutamic acid and L-asparagine. Further compounds having sour taste from Group 11 are peptides, preferably peptides including the amino acids glycine-asparagine, glycine-glutamine, alanine-asparagine, alanine-glutamine, serine-asparagine, serine-glutamine, valine-asparagine, valine-glutamine, asparagine-alanine, asparagine-asparagine, glutamine-alanine, glutamine-asparagine, glutamine-glutamine, phenylalanine-asparagine, phenylalanine-glutamine, glycine-asparagine-serine-glycine, proline-glycine-glycine-glutamine and valine-valine-glutamine.

To match the taste impression “sour”, inorganic hydroxides can be added to the compounds of Group 11, preferably sodium hydroxide, magnesium hydroxide and calcium hydroxide.

Compounds of Group 12 which give astringent and bitter taste properties are L-amino acids, preferably L-histidine, L-methionine, L-valine, L-arginine, L-isoleucine, L-phenylalanine, L-tryptophan, L-leucine, L-glutamine and L-tyrosine. Further compounds of Group 12 are peptides, preferably of the amino acids glycine-leucine, leucine-phenylalanine, leucine-lysine, arginine-leucine, arginine-leucine-leucine, serine-lysine-glycine-leucine, pyroglutamine-glycine-serine-alanine-isoleucine-phenylalanine-valine-leucine, tyrosine, phenylalanine-leucine, phenyl-alanine-leucine, alanine-isoleucine-alanine, alanine-alanine-leucine, glycine-alanine-leucine, leucine-glutamine-leucine-leucine-glutamine-leucine, leucine-valine-leucine, leucine-proline-phenylalanine-asparagine-glycine-leucine, leucine-proline-phenylanaline-serine-glycine-leucine, alanine-glycine-tyrosine-glycine-serine-leucine-valine-tyrosine-proline-phenylalanine-proline-glycine-proline-isoleucine-proline-asparagine -serine-leucine-proline-glutamine-asparagine-isoleucine-proline-proline-leucine-tyrosine-glutamine, glycine-proline-phenylalanine-proline-valine-isoleucine, phenylalanine-phenylalanine-valine-alanine-proline-proline-glutamine-valine-phenylalanine-glycine-lysine, argenine-glycine-proline-proline-phenylalanine-isoleucine-valine, valine-tyrosine-proline-phenylalanine-proline-proline-glycine-isoleucine-argenine-histidine and cyclo-leucine-tyrosine-leucine-tyrosine. Further mentioned as compounds of Group 12 having astringent or bitter taste properties are unsaturated fatty acids having 16 to 22 carbon atoms. Preferred compounds of Group 12 are oleic acid and linoleic acid.

Compounds of Group 13 which give sweet taste properties are carbohydrates, preferably glucose, fructose, lactose and sucrose and L-amino acids, preferably L-alanine, L-glycine, L-serine, L-threonine, L-lysine, L-proline.

Compounds of Group 14 having umami-like taste properties are L-amino acids, preferably sodium glutamate, sodium aspartate. Further compounds having umami-like taste are peptides based on amino acids glutamine-glutamine, glutamine-asparagine, threonine-glutamine, glutamine-serine, glutamine-glycine-serine, serine-glutamine-glutamine, glutamine-glutamine-glutamine, glutamine, asparagine-glutamine.

Furthermore, it has been found that mixing individual compounds with yeast extract and/or milk fat products and vegetable fat products in non-perishable baked goods, crackers and cheese sauces and also bread spreads, gives a cheese flavor with rounded notes and a particular mouth feel. This also applies in uses of these compounds of the groups with yeast extract and/or milk fat products and vegetable fat products, including in extruded foods.

The selection of the individual groups and individual compounds for various cheese types is made by qualitative and quantitative analysis of individual cheese varieties by food analysis methods known per se (Z. Lebensm. Unters. Forsch. (1996) 202: 30-34). A preferred selection process is described as follows:

The concentrations of odor-active substances and taste-active substances in cheese varieties are determined using analytical methods of food chemistry. The substances which are important for cheese flavoring are selected by determining the so-called odor activity values (OAV) and taste activity values (TAV) (Z. Lebensm. Unters. Forsch., 1996, 203:230-235). OAV and TAV data are obtained from the quotient of the respective concentration of a compound and the corresponding threshold value in a relevant matrix or water. All substances having OAVs or TAVs which are greater than 1 are taken into account for preparing model mixtures. Using a specific model system based on carbohydrate and vegetable fat, a test is made as to which substances are necessary for producing the inventive cheese flavoring. Furthermore, using this model system, quantitative matching with flavoristic methods is performed.

A preferred embodiment of cheese flavoring is the flavor “cheddar” with the following composition: volatile component contents ranging from 20 to 200 parts by weight of compounds having acidic and acetic-acid-like flavors (Group 1), from 0.5 to 10 parts by weight of compounds having milky and creamy flavors or cream-like or caramel-like flavors (Group 2), from 0.1 to 2.0 parts by weight of compounds having fruity and flowery flavors (Group 3), from 0.05 to 0.8 parts by weight of compounds having strong flavors, blue mold flavors and rind flavors (Group 4), from 0.04 to 1.0 parts by weight of compounds having fatty flavors (Group 5), from 0.0001 to 0.005 parts by weight of compounds having animal flavors (Group 6), from 0.002 to 0.2 parts by weight of compounds having roasted flavors and cocoa-like flavors and smoky flavors (Group 7), from 0.001 to 0.06 parts by weight of compounds having vegetable-like flavors (Group 8), from 0.001 to 0.08 parts by weight of mushroom-like flavors or soft-cheese-like flavors (Group 9) and non-volatile component contents of from 100 to 350 parts by weight of compounds having the taste impression salty (Group 10), from 80 to 280 parts by weight of compounds having the taste impression sour (Group 11), from 5 to 40 parts by weight of compounds having astringent, bitter notes (Group 12), from 0 to 50 parts by weight of compounds having the taste impression sweet (Group 13) and from 0 to 80 parts by weight of compounds having a glutamate-like taste impression (umami) (Group 14).

Another preferred embodiment is cheese flavoring of the flavor “parmesan” with the following composition: volatile component contents ranging from 5 to 75 parts by weight of compounds having acidic and acetic-acid-like flavors (Group 1), from 0.2 to 5.0 parts by weight of compounds having milky and creamy flavors or cream-like or caramel-like flavors (Group 2), from 0.2 to 3.0 parts by weight of compounds having fruity and flowery flavors (Group 3), from 0.1 to 2.6 parts by weight of compounds having strong flavors, blue mold flavors and rind flavors (Group 4), from 0.04 to 0.8 parts by weight of compounds having fatty flavors (Group 5), from 0.001 to 0 .02 parts by weight of compounds having animal flavors (Group 6), from 0.03 to 0.5 parts by weight of compounds having roasted flavors and cocoa-like flavors and smoky flavors (Group 7), from 0.0005 to 0.006 parts by weight of compounds having vegetable-like flavors (Group 8), from 0 to 0.014 parts by weight of mushroom-like flavors or soft-cheese-like flavors (Group 9) and non-volatile component contents of from 200 to 350 parts by weight of compounds having the taste impression salty (Group 10), from 200 to 400 parts by weight of compounds having the taste impression sour (Group 11), from 70 to 200 parts by weight of compounds having astringent, bitter notes (Group 12), from 20 to 100 parts by weight of compounds having the taste impression sweet (Group 13) and from 0 to 100 parts by weight of compounds having a glutamate-like taste impression (umami) (Group 14).

The inventive cheese flavoring is produced by mixing the individual compounds from the individual groups.

Preferably, a premix is produced from the volatile components and the non-volatile compounds and these are mixed during production of the food to be flavored.

The invention also relates to the use of the inventive cheese flavoring in foods. In this manner, the flavor experience “cheese” is induced in the food.

The invention also relates to foods which contain the inventive cheese flavoring.

For example, the following fields of application in foods may be mentioned in Table 2:

TABLE 2

| Fields of | | | End |
|---|---|---|---|
| application | Application types | Technology | product |
| Snacks | Seasoning compositions, | Sprinkled-on | Potato-corn |
| | seasoning preparations, | seasoning, | chips, |
| | seasoning salts, | oil slurry, | extrudates, |
| | preparations | fat filling | pellets and |
| | containing seasoning | and dough | popcorn |
| | ingredients, seasoning | flavoring | |
| | flavor compositions, | | |
| | seasoning flavoring salts, | | |
| | spices, spice mixtures, | | |
| | spice | | |
| | sauces and dry mixes | | |
| Non-perishable | Flavoring, seasoning | Dough | Crackers and |
| baked goods | compositions, seasoning | flavoring, | biscuits |
| | preparations, seasoning | oil slurry, | |
| | salts, preparations | fat filling | |
| | containing seasoning | and | |
| | ingredients, seasoning | sprinkled-on | |
| | flavor compositions, | seasoning | |
| | seasoning flavoring salts, | | |
| | spices, spice mixtures | | |
| | and spice | | |
| | sauces | | |
| Ready meal/ | Dry mixes, preserved | Instant | Ready-to-eat |
| sauces | products, seasoning | dry mix, | soup and |
| | compositions, seasoning | UHT | ready-to-eat |
| | preparations, seasoning | treatment | sauce |
| | salts, preparations | and | |
| | containing seasoning | sterilization | |
| | ingredients, seasoning | | |
| | flavor compositions, | | |
| | seasoning flavoring salts, | | |
| | spices, spice mixtures | | |
| | and spice | | |
| | sauces | | |
| Cheese pastes | Flavoring, seasoning | Instant | Bread spread, |
| | compositions, seasoning | dry mix, | vegetable |
| | preparations, seasoning | UHT | cheese, |
| | salts, preparations | treatment | imitation |
| | containing seasoning | and | cheese |
| | ingredients, seasoning | sterilization | and processed |
| | flavor compositions, | | cheese |
| | seasoning flavoring salts, | | |
| | spices, spice mixtures | | |
| | and spice | | |
| | sauces | | |

Snacks are savory snack items which include, inter alia, potato-corn chips, extrudates, pellets, popcorn, pretzels and fat-fried and oven-baked dough products. The inventive cheese flavoring is employed for using the snack or for rounding off the snack. The cheese flavoring can be applied via sprinkled-on seasoning, sprayed-on oil slurry, fat filling or dough flavoring. In the various seasoning forms, the cheese flavoring is added to “carriers” such as sprinkled seasoning and oil slurry.

Crackers are baked dough products and are included in the seasoned snack items; they are flavored via spraying on an oil slurry or via a fat filling.

Convenience products such as ready meals, partial meals, sauces, dressings and dips are offered in various forms. Those which are usual are the dried, sterilized, pasteurized, chilled and frozen application forms.

The cheese flavoring can, in all application forms, either be added via a dry, pasty or liquid premix, or else as such, without needing to have been mixed in advance with the other constituents. The time point of addition depends on the application form and the production process.

Dry instant products are pure dry mixes of foods, food preparations, additives, aids and/or flavorings.

Sterilized products are long shelf life products having a relatively high water content which requires that the products are preserved via a heating process. In this case both the living microorganisms and the spores must be destroyed.

Pasteurized products also have a relatively high water content which generally corresponds to the water content of the product. These are preserved in various ways. They can be preserved by heating, a low pH, osmosis (use of sugar-salt), preservatives and/or cooling.

Other application forms are processed cheese and imitation cheese (recombined cheese made of protein, fat, water and stabilizers).

No additives or fillers are required for the inventive cheese flavorings. The necessary aroma substances may be combined freely from the individual groups and in this manner make it possible to produce application-specific mixtures.

The inventive cheese flavorings surprisingly enable the preparation of all flavors typical of a variety without being bound to constituents which do not contribute to the taste sensation “cheese”.

In a preferred embodiment of the present invention, a premix A, containing constituents of Groups 1 to 9, is combined with a premix B, containing constituents of Groups 10 to 14. Premix A can be present in liquid form and in a formulated form, such as, for example in a spray-dried or encapsulated form.

The production of industrial cheese preparations having the cheese flavoring according to the present invention is carried out with ingredients of Groups 1 to 14. The mixture for industrial plant-fat-based cheese preparations is prepared according to the formula in Table 3 below.

TABLE 3
Formula example for the production of industrial cheese
preparations (the values are in percent):

| Ingredients | min. | max. |
|---|---|---|
| Water | 60 | 65 |
| Hardened fat | 20 | 23 |
| Phosphates E450c, E450a | 1.8 | 2.2 |
| Granulated milk protein | 11 | 12 |
| Sodium chloride | 0.5 | 0.6 |
| Citric acid | 0.4 | 0.5 |
| β-Carotene | 0.05 | 0.06 |

Here, premix A, containing constituents of Groups 1 to 9, is combined with premix B, containing constituents of Groups 10 to 14. The mixing ratio of the cheese flavoring according to the present invention is 20 to 30 parts of premix A in relation to 600 to 800 parts of premix B. The entire flavoring mixture is added in a portion of 0.01 to 10% of the basic formula, and preferably an amount in the range from 0.1 to 3% is added.

The invention also relates to foods, which contain the cheese flavoring according to the present invention, such as, for example, bread spreads or fillings for baked goods.

The production of industrial baked goods of the cracker type having the cheese aroma according to the present invention is carried out with ingredients of Groups 1 to 14. The mixture for crackers can be prepared according to the formula in Table 4 below.

TABLE 4
Formula example for producing crackers (the values are in percent):

| Ingredients | min. | max. |
|---|---|---|
| Wheat flour | 60 | 63 |
| Baking powder | 1.0 | 1.5 |
| Soft vegetable fat | 6.0 | 6.5 |
| Maltose syrup | 2.0 | 2.5 |
| Emulsifier | 1.2 | 1.8 |
| Spray-dried skimmed milk | 1.0 | 1.5 |
| powder | | |
| Ammonium bicarbonate | 1.5 | 2.0 |
| Fresh baker's yeast | 0.3 | 0.9 |
| Common salt | 0.3 | 0.6 |
| Make-up water | 20.0 | 23.5 |

Here, premix A, containing constituents of Groups 1 to 9, is combined with premix B, containing constituents of Groups 10 to 14. The mixing ratio of the inventive cheese flavoring in non-perishable baked goods and, in particular, crackers, is 150 to 220 parts of premix A to 170 to 250 parts of premix B. The entire aroma mixture is added in a portion of 0.05 to 10% of the basic formula, and preferably an amount in the range from 0.5 to 5% is added.

The production of industrial seasonings for snacks having the cheese aroma according to the present invention is carried out with ingredients of Groups 1 to 14. The mixture for seasonings can be prepared according to the formula in Table 5 below.

TABLE 5
Formula example for producing seasonings (the values are in percent):

| Ingredients | min. | max. |
|---|---|---|
| Salt | 12 | 25 |
| Carrier (e.g. powdered whey) | 40 | 60 |
| Fillers (e.g. powdered fat) | 5 | 15 |
| Flavor enhancers | 1.8 | 3.8 |
| Technological auxiliaries | 0.1 | 5 |
| (e.g. silica) | | |
| Cheese powder | 10 | 50 |
| Hydrolyzed vegetable proteins | 5 | 10 |
| Yeast extract | 5 | 15 |
| Seasonings | 1 | 5 |
| Acidifying agents (e.g. citric | 0.1 | 1.0 |
| acid) | | |
| Colorant (e.g. paprika extract) | 0.1 | 1.0 |

Here, premix A, containing constituents of Groups 1 to 9, is combined with premix B, containing constituents of Groups 10 to 14. The mixing ratio of the cheese aroma according to the invention in non-perishable baked goods, and in particular crackers, is 5 to 100 parts of premix A to 130 to 500 parts of premix B. The entire aroma mixture is added in a portion of 1.0 to 20% of the basic formula, and preferably an amount in the range from 5 to 15% is added.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A cheese flavoring comprising:
A) volatile component contents comprising
i) from 5 to 200 parts by weight of compounds having acidic and acetic-acid-like flavors (Group 1);
ii) from 0.1 to 10.0 parts by weight of compounds having milk-like and creamy flavors or cream-like or caramel-like flavors (Group 2);
iii) from 0.03 to 6.0 parts by weight of compounds having fruity and flowery flavors (Group 3);
iv) from 0.01 to 15.0 parts by weight of compounds having strong flavors, blue mold flavors and rind flavors (Group 4);
v) from 0.003 to 15.0 parts by weight of compounds having fatty flavors (Group 5);
vi) from 0 to 0.05 parts by weight of compounds having animal flavors (Group 6);
vii) from 0.0003 to 0.6 parts by weight of compounds having roasted flavors and cocoa-like flavors and also smoky flavors (Group 7);
viii) from 0.00005 to 0.1 parts by weight of compounds having vegetable-like flavors (Group 8);
ix) from 0 to 0.1 parts by weight of compounds having mushroom-like flavors or soft-cheese-like flavors (Group 9);
B) non-volatile component contents comprising:
i) from 100 to 480 parts by weight of compounds having the taste impression salty (Group 10);
ii) from 50 to 550 parts by weight of compounds having the taste impression sour (Group 11);
iii) from 5 to 200 parts by weight of compounds having astringent, bitter notes (Group 12);
iv) from 0 to 100 parts by weight of compounds having the taste impression sweet (Group 13); and
v) from 0 to 140 parts by weight of compounds having a glutamate-like taste impression (umami) (Group 14).

2. A cheese flavor according to claim 1 wherein the cheese flavor is a cheddar cheese flavor, said flavor comprising
A) volatile component contents comprising
i) from 20 to 200 parts by weight of compounds having acidic and acetic-acid-like flavors (Group 1);
ii) from 0.5 to 10 parts by weight of compounds having milky and creamy flavors or cream-like or caramel-like flavors (Group 2);
iii) from 0.1 to 2.0 parts by weight of compounds having fruity and flowery flavors (Group 3);
iv) from 0.05 to 0.8 parts by weight of compounds having strong flavors, blue mold flavors and rind flavors (Group 4);
v) from 0.04 to 1.0 parts by weight of compounds having fatty flavors (Group 5);
vi) from 0.0001 to 0.005 parts by weight of compounds having animal flavors (Group 6),
vii) from 0.002 to 0.2 parts by weight of compounds having roasted flavors and cocoa-like flavors and smoky flavors (Group 7);
viii) from 0.001 to 0.06 parts by weight of compounds having vegetable-like flavors (Group 8);
ix) from 0.001 to 0.08 parts by weight of compounds having mushroom-like flavors or soft-cheese-like flavors (Group 9); and
B) non-volatile component contents comprising
i) from 100 to 350 parts by weight of compounds having the taste impression salty (Group 10);
ii) from 80 to 280 parts by weight of compounds having the taste impression sour (Group 11),
iii) from 5 to 40 parts by weight of compounds having astringent, bitter notes (Group 12);
iv) from 0 to 50 parts by weight of compounds having the taste impression sweet (Group 13); and
v) from 0 to 80 parts by weight of compounds having a glutamate-like taste impression (umami) (Group 14).

3. A cheese flavoring according to claim 1, wherein said cheese flavor is a Parmesan flavor, said flavor comprising:
A) volatile component contents comprising
i) from 5 to 75 parts by weight of compounds having acidic and acetic-acid-like flavors (Group 1);
ii) from 0.2 to 5.0 parts by weight of compounds having milky and creamy flavors or cream-like or caramel-like flavors (Group 2);
iii) from 0.2 to 3.0 parts by weight of compounds having fruity and flowery flavors (Group 3);
iv) from 0.1 to 2.6 parts by weight of compounds having strong flavors, blue mold flavors and rind flavors (Group 4);
v) from 0.04 to 0.8 parts by weight of compounds having fatty flavors (Group 5);
vi) from 0.001 to 0.02 parts by weight of compounds having animal flavors (Group 6);
vii) from 0.03 to 0.5 parts by weight of compounds having roasted flavors and cocoa-like flavors and smoky flavors (Group 7);
viii) from 0.0005 to 0.006 parts by weight of compounds having vegetable-like flavors (Group 8);
ix) from 0 to 0.014 parts by weight of mushroom-like flavors or soft-cheese-like flavors (Group 9);
B) non-volatile component contents comprising
i) from 200 to 350 parts by weight of compounds having the taste impression salty (Group 10);
ii) from 200 to 400 parts by weight of compounds having the taste impression sour (Group 11);
iii) from 70 to 200 parts by weight of compounds having astringent, bitter notes (Group 12);
iv) from 0 to 100 parts by weight of compounds having the taste impression sweet (Group 13); and
v) from 20 to 100 parts by weight of compounds having a glutamate-like taste impression (umami) (Group 14).

4. A cheese flavoring according to claim 1, wherein yeast extract and/or milk fat or vegetable fat products are added as a flavor enhancer and for rounding.

5. A cheese flavoring according to claim 1, wherein said compounds having acidic and acetic-acid-like flavors (Group 1) is selected from the group consisting of carboxylic acids having from 2 to 16 carbon atoms.

6. A cheese flavoring according to claim 5, wherein said carboxylic acids having from 2 to 16 carbon atoms are selected from the group consisting of acetic acid, propionic acid, butyric acid, valeric acid, caprylic acid, caproic acid, capric acid, lauric acid and myristic acid.

7. A cheese flavoring according to claim 1, wherein said compounds having milk-like and creamy flavors or cream-like or caramel-like flavors (Group 2) are selected from the group consisting of saturated and unsaturated δ- and γ-lactone having 6 to 14 carbon atoms, hydroxy ketones and diketones having 4 to 8 carbon atoms and aromatic aldehydes.

8. A cheese flavoring according to claim 7, wherein said saturated and unsaturated δ- and γ-lactone having 6 to 14 carbon atoms are selected from the group consisting of jasmine lactone, δ-decalactone, δ-octalactone, δ-undecalactone, δ-dodecalactone and δ-tetradecalactone and γ-caprolactone, γ-heptalactone, γ-octalactone, γ-decalactone and γ-dodecalactone.

9. A cheese flavoring according to claim 1, wherein said compounds having fruity and flowery flavors (Group 3) are selected from the group consisting of ethyl, propyl and butyl esters of unbranched and branched carboxylic acids having 2 to 12 carbon atoms, saturated, unsaturated, unbranched and branched alcohols and aldehydes.

10. A cheese flavoring according to claim 9, wherein said ethyl, propyl and butyl esters of unbranched and branched carboxylic acids having 2 to 12 carbon atoms are selected from the group consisting of ethyl propionate, ethyl butyrate, ethyl caprylate, ethyl caprate, ethyl caproate, ethyl isobutyrate, ethyl isovalerate and also propyl caprylate and butyl acetate.

11. A cheese flavoring according to claim 9, wherein said saturated, unsaturated, unbranched and branched alcohols is selected from the group consisting of 2-pentanol, isoamyl alcohol, hexanol, methyl 2-methylbutyrate, 3-methyl-2-butenol and 2-phenylethyl alcohol.

12. A cheese flavoring according to claim 9, wherein said aldehyde is selected from the group consisting of benzaidehyde, phenylacetaldehyde and (E)-2-phenylbutenal.

13. A cheese flavoring according to claim 1, wherein said compounds having strong flavors, blue mold flavors and rind flavors (Group 4) are 2-alkanones and 2-alkanols having 5 to 12 carbon atoms.

14. A cheese flavoring according to claim 13, wherein said 2-alkanones are selected from the group consisting of 2-pentanone, 2-heptanone, 2-octanone, 2-decanone and 2-nonanone.

15. A cheese flavoring according to claim 13, wherein said 2-alkanols are selected from the group consisting of 2-heptanol and 2-nonanol.

16. A cheese flavoring according to claim 1, wherein said compounds having fatty and creamy flavors (Group 5) are unbranched aliphatic aldehydes and alcohols having from 7 to 14 carbon atoms, unsaturated adehydes having 8 to 15 carbon atoms and 2-alkanones having 6 to 16 carbon atoms and esters of long-chain unbranched fatty acids.

17. A cheese flavoring according to claim 1, wherein said compounds having animal flavors (Group 6) are selected from the group consisting of nitrogen compounds, sulfur compounds, and branched fatty acids.

18. A cheese flavoring according to claim 1, wherein said compounds having roasted flavors and cocoa-like flavors and also smoky flavors (Group 7) are selected from the group consisting of pyrazines which are monosubstituted or polysubstituted (monosubstituted to trisubstituted) with lower alkyl groups, branched aldehydes having 4 and 5 carbon atoms, phenols and alkylfurans.

19. A cheese flavoring according to claim 1, wherein said compounds having vegetable-like flavors (Group 8) are selected from the group consisting of lower-alkyl-substituted thio compounds (1 to 4 carbon atoms), thiols and thioaldehydes.

20. A cheese flavoring according to claim 1, wherein said compounds having mushroom-like flavors or soft-cheese-like flavors (Group 9) are selected from the group consisting of saturated and unsaturated alcohols and ketones having 8 carbon atoms.

21. A cheese flavoring according to claim 1, wherein said compounds having the taste impression salty (Group 10) are salts having cations selected from the group consisting of sodium, ammonium, potassium, magnesium and calcium and anions such as chloride, hydrogen phosphate, dihydrogen phosphate, acetate and sulfate.

22. A cheese flavoring according to claim 1, wherein said compounds having th e t aste impression sour (Group 11) are inorganic hydroxides.

23. A cheese flavoring according to claim 1, wherein said compounds having astringent, bitter notes (Group 12) are selected from the group consisting of L-amino acids, peptides and unsaturated fatty acids having 16 to 22 carbon atoms.

24. A cheese flavoring according to claim 1, wherein said compounds having the taste impression sweet (Group 13) are selected from the group consisting of carbohydrates and L-amino acids.

25. A cheese flavoring according to claim 1, wherein said compounds having a glutamate-like taste impression (Group 14) are selected from the group consisting of L-amino acids and peptides based on amino acids.

26. A food product containing a cheese flavoring which comprises:
A) volatile component contents comprising
i) from 5 to 200 parts by weight of compounds having acidic and acetic-acid-like flavors (Group 1);
ii) from 0.1 to 10.0 parts by weight of compounds having milk-like and creamy flavors or cream-like or caramel-like flavors (Group 2);
iii) from 0.03 to 6.0 parts by weight of compounds having fruity and flowery flavors (Group 3);
iv) from 0.01 to 15.0 parts by weight of compounds having strong flavors, blue mold flavors and rind flavors (Group 4);
v) from 0.003 to 15.0 parts by weight of compounds having fatty flavors (Group 5);
vi) from 0 to 0.05 parts by weight of compounds having animal flavors (Group 6);
vii) from 0.0003 to 0.6 parts by weight of compounds having roasted flavors and cocoa-like flavors and also smoky flavors (Group 7);
viii) from 0.00005 to 0.1 parts by weight of compounds having vegetable-like flavors (Group 8);
ix) from 0 to 0.1 parts by weight of compounds having mushroom-like flavors or soft-cheese-like flavors (Group 9);
B) non-volatile component contents comprising:
i) from 100 to 480 parts by weight of compounds having the taste impression salty (Group 10);
ii) from 50 to 550 parts by weight of compounds having the taste impression sour (Group 11);
iii) from 5 to 200 parts by weight of compounds having astringent, bitter notes (Group 12);
iv) from 0 to 100 parts by weight of compounds having the taste impression sweet (Group 13); and
v) from 0 to 140 parts by weight of compounds having a glutamate-like taste impression (umami) (Group 14).

27. A food product according to claim 26, wherein said cheese flavor is a cheddar cheese flavor, said flavor comprising
A) volatile component contents comprising
i) from 20 to 200 parts by weight of compounds having acidic and acetic-acid-like flavors (Group 1);
ii) from 0.5 to 10 parts by weight of compounds having milky and creamy flavors or cream-like or caramel-like flavors (Group 2);
iii) from 0.1 to 2.0 parts by weight of compounds having fruity and flowery flavors (Group 3);
iv) from 0.05 to 0.8 parts by weight of compounds having strong flavors, blue mold flavors and rind flavors (Group 4);
v) from 0.04 to 1.0 parts by weight of compounds having fatty flavors (Group 5);
vi) from 0.0001 to 0.005 parts by weight of compounds having animal flavors (Group 6),
vii) from 0.002 to 0.2 parts by weight of compounds having roasted flavors and cocoa-like flavors and smoky flavors (Group 7);
viii) from 0.001 to 0.06 parts by weight of compounds having vegetable-like flavors (Group 8);
ix) from 0.001 to 0.08 parts by weight of compounds having mushroom-like flavors or soft-cheese-like flavors (Group 9); and
B) non-volatile component contents comprising
i) from 100 to 350 parts by weight of compounds having the taste impression salty (Group 10);
ii) from 80 to 280 parts by weight of compounds having the taste impression sour (Group 11),
iii) from 5 to 40 parts by weight of compounds having astringent, bitter notes (Group 12);
iv) from 0 to 50 parts by weight of compounds having the taste impression sweet (Group 13); and
v) from 0 to 80 parts by weight of compounds having a glutamate-like taste impression (umami) (Group 14).

28. A food product according to claim 26, wherein said cheese flavor is a Parmesan cheese flavor, said flavor comprising:
A) volatile component contents comprising
i) from 5 to 75 parts by weight of compounds having acidic and acetic-acid-like flavors (Group 1);
ii) from 0.2 to 5.0 parts by weight of compounds having milky and creamy flavors or cream-like or caramel-like flavors (Group 2);
iii) from 0.2 to 3.0 parts by weight of compounds having fruity and flowery flavors (Group 3);
iv) from 0.1 to 2.6 parts by weight of compounds having strong flavors, blue mold flavors and rind flavors (Group 4);
v) from 0.04 to 0.8 parts by weight of compounds having fatty flavors (Group 5);
vi) from 0.001 to 0.02 parts by weight of compounds having animal flavors (Group 6);
vii) from 0.03 to 0.5 parts by weight of compounds having roasted flavors and cocoa-like flavors and smoky flavors (Group 7);
viii) from 0.0005 to 0.006 parts by weight of compounds having vegetable-like flavors (Group 8);
ix) from 0 to 0.014 parts by weight of compounds having mushroom-like flavors or soft-cheese-like flavors (Group 9);
B) non-volatile component contents comprising
i) from 200 to 350 parts by weight of compounds having the taste impression salty (Group 10);
ii) from 200 to 400 parts by weight of compounds having the taste impression sour (Group 11);
iii) from 70 to 200 parts by weight of compounds having astringent, bitter notes (Group 12);
iv) from 0 to 100 parts by weight of compounds having the taste impression sweet (Group 13); and
v) from 20 to 100 parts by weight of compounds having a glutamate-like taste impression (umami) (Group 14).
